(19) United States
(12) Patent Application Publication
(10) Pub. No.: US 2007/0011731 A1
(43) Pub. Date: Jan. 11, 2007

(54) Method, system & computer program product for discovering characteristics of middleboxes

(75) Inventors: Franck Le, Pittsburgh, PA (US); Stefano Faccin, Dallas, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/173,215

(22) Filed: Jun. 30, 2005

(51) Int. Cl. G06F 15/16

(52) U.S. Cl. 726/11

(57) ABSTRACT

A method, computer program product, communications device and system for enabling an end node or terminal to discover one or more characteristics of a firewall on the communications path between the end node and a data network are provided. In particular, middlebox configuration protocols have been extended to allow a user to run additional tests in order to determine, for example, whether a discovered firewall blocks unsolicited incoming requests, as well as what the length of time associated with a particular state created by the discovered firewall is.

### FIELD OF THE INVENTION

This invention relates to wireless communications, and more particularly to mechanisms used to protect wireless subscribers.

### BACKGROUND OF THE INVENTION

In wireless networks, attacks to mobile terminals are often more harmful than in traditional IP networks. This is based on the fact that bandwidth over the air interface is limited and costly, and users generally must pay for every packet sent over the access link. Mobile terminals are also more vulnerable since they typically have less memory and CPU (Central Processing Unit) capabilities, causing Denial of Service attacks to be more damaging and easier to carrier out than in traditional IP networks.

Various mechanisms have been developed to protect wireless subscribers, as well as operators of other wired communications devices, including, for example, the development of various middleboxes. A middlebox is a device within a network that enforces transport policy. An example of a middlebox is a firewall. Firewalls are the primary method for keeping a computer secure from intruders. They allow or block traffic into and out of a private network or the user's computer based on various criteria. For example, a Packet Filter is one example of a firewall technique that blocks traffic based on a specific IP address or type of application (e.g., email, ftp, Web, etc.), which is specified by port number. This is typically done using a router known as a “screening router.” A Stateful Inspection, which is another example of a firewall technique, tracks each transaction to ensure that inbound packets were requested by the user. These techniques are often used by themselves or in some combination thereof.

Another technique is the use of Network Access Translation (NAT) technology, which can be implemented in routers, firewalls or personal computers (PCs). NAT is an IETF (Internet Engineering Taskforce) standard that allows an organization to present itself to the Internet with fewer IP addresses than there are nodes on its internal network. NAT technology can be implemented to convert private IP addresses of a machine on the internal private network to one or more public IP addresses for the Internet. In addition to conserving public IP addresses, NATs also enhance security by keeping internal addresses hidden from the outside world.

NATs, though beneficial in many ways, come with many drawbacks. For example, NATs can break many existing IP applications and may make it difficult to deploy new ones. Protocols that are particularly difficult to construct according to NAT-friendly guidelines include almost all peer-to-peer (P2P) protocols, such as multimedia communications, file sharing and games.

Simple Traversal of User Datagram Protocol (UDP) through Network Address Translators (NATs) (STUN) is a lightweight protocol that was designed to deal with some of the issues relating to NATs. STUN, which is described in Network Working Group, Request for Comment: 3489, March 2003, the contents of which are incorporated herein by reference in their entirety, allows applications to discover the presence of NATs and firewalls between the applications and the public Internet. STUN further enables the applications to determine the type of NAT discovered and the public Internet Protocol (IP) addresses allocated to them by the NAT.

FIG. 1 illustrates a typical STUN configuration. As shown, a STUN Client 110, which generates STUN requests and transmits them to a STUN Server 120, is connected to a private network (Private NET 1). The STUN Client 110 may be an application running on a user's equipment (UE), such as a personal computer (PC), laptop, cellular telephone, portable digital assistant (PDA), or other similar device, or in a network element, such as a conferencing server. Private NET 1 connects to a second private network (Private NET 2) through a first NAT (NAT 1) 130. Private NET 2 in turn connects to the public Internet through a second NAT (NAT 2) 140. The STUN Server 120, which receives the STUN requests and sends STUN responses to the STUN Client 110, typically resides on the public Internet.

As stated above, the STUN Client sends a request to the STUN Server, which in turn returns a response. There are two types of requests—Binding Requests, sent over UDP, and Shared Secret Requests, sent over TLS (Transport Layer Security) over TCP (Transmission Control Protocol). Shared Secret Requests ask the server to return a temporary username and password, which are then used in a subsequent Binding Request and Binding Response for the purposes of authentication and message integrity.

Binding Requests are used to discover the presence of a NAT and to determine the public IP address and port mappings generated by the NAT. The client sends a Binding Request to the server, over UDP. The server examines the source IP address and port of the request, and copies them into a response that is sent back to the client. Where the Binding Request has passed through one or more NATs between the STUN Client and the STUN Server, the source address of the request received by the server will be the mapped address created by the NAT closest to the server. The STUN server copies that source IP address and port into the STUN Binding Response, and sends it back to the source IP address and port of the STUN Request. Once the STUN Client receives the Binding Response, it compares the IP address and port in the packet with the local IP address and port it bound to when the request was sent. If the addresses and ports do not match, then the STUN Client knows that one or more NATs are between it and the STUN Server.

Certain parameters may be used in the request to allow the STUN Client to ask that the Binding Response be sent elsewhere, or that the STUN Server send the response from a different IP address or port. Using these parameters, the client can determine not only whether one or more NATs lie between it and the server, but also what type (i.e., Full Cone NAT, Restricted Cone NAT, Port Restricted Cone NAT, or Symmetric NAT). The following attributes have been defined to carry these parameters: (1) MAPPED-ADDRESS attribute; (2) RESPONSE-ADDRESS attribute; (3) CHANGE-REQUEST attribute; (4) CHANGED-ADDRESS attribute; and (5) SOURCE-ADDRESS attribute.

The MAPPED-ADDRESS attribute contains the IP address and port that is placed in the Binding Response that indicates the source IP address and port the server saw in the Binding Request, discussed above. The RESPONSE-ADDRESS attribute also contains an IP address and port. However, this attribute may be placed in the STUN Binding Request to indicate where the Binding Response is to be sent. Where the RESPONSE-ADDRESS attribute is not present in the Binding Request, the Binding Response is sent to the source IP address and port, as discussed above.

The CHANGE-REQUEST attribute contains two flags, called “change IP” and “change port,” to control the IP address and port used to send the Binding Response. Like the RESPONSE-ADDRESS, the CHANGE-REQUEST attribute may be placed in the STUN Binding Request. These flags are used to instruct the STUN server to send the Binding Request from a different source IP address and/or port, and are therefore useful for determining what type of NAT the STUN Client is behind. For example, a Full Cone NAT maps all requests from the same internal IP address and port to the same external IP address and port. In addition, any external host can send a packet to the internal host, by sending a packet to the mapped external address. If the STUN Client sends a Binding Request including either the “change IP” or the “change port” flag telling the STUN server to send the response from a different IP address and/or port than the request was received on, and the STUN Client receives the Binding Response, the STUN Client knows that it is behind a Full Cone NAT. By contrast, where the STUN Client does not receive the Binding Response, it may be behind, for example, a Restricted Cone NAT, since a Restricted Cone NAT will only allow an external host (e.g., with IP address X) to send a packet to the internal host if the internal host had previously sent a packet to IP address X. Similarly, the STUN Client may be behind a Port Restricted Cone NAT, which further restricts Binding Responses to external hosts having the same IP address and port to which the internal host had previously sent a packet.

The CHANGED-ADDRESS attribute is present in the Binding Response and informs the STUN Client of the source IP address and port that would be used if the client requested the “change IP” and “change port” behavior. Finally, the SOURCE-ADDRESS attribute, which is also present in the Binding Response, indicates the source IP address and port from where the Binding Response was sent. This attribute is useful for discovering where there are two or more NATs.

While the STUN protocol is useful for discovering whether there is a NAT or firewall, it is mainly targeted to NATs and is limited to determining what type of NAT has been discovered. STUN does not enable a user to determine characteristics of a discovered firewall. Like NATs, firewalls pose many problems for various applications. For instance, for Session Initiation Protocol (SIP) based applications, without the appropriate pinholes open in a firewall, an incoming media stream may be dropped at the firewall. In addition, for P2P file sharing, unless a user is able to receive incoming requests, the application cannot run successfully. Similarly, for the Mobile IP protocol, depending on the configuration of the firewalls, there may be many issues that may prevent the packets from reaching the recipient.

Various solutions to these problems have been proposed. For example, for P2P applications, it has been proposed to use a relay in the public Internet where both peers would connect to and encapsulate the packets in HTTP (Hypertext Transfer Protocol). For Mobile IP, different alternatives to the Return Routability Test have also been proposed, each having different characteristics. Determining which solution is best suited for each problem often depends on the configuration of the firewall.

In order for a node (e.g., the UE) to know which solution to adopt and use, the node must first determine, not only whether the node is behind a firewall, but also what the characteristics of that firewall are (e.g., does it allow incoming requests, what ports does it authorize, what is the lifetime of the state dynamically created by the firewall, etc.). This information may be useful, for example, for dynamically opening pinholes in the firewall. For example, Stateful Inspection Packet Filters, an example of a firewall technique, typically create a state that persists for a pre-determined period of time upon receiving a request from a node in a protected environment. Incoming packets matching the state are allowed to pass the firewall during the pre-determined period of time. After the pre-determined period of time has passed, the state is removed and incoming packets are no longer allowed to pass. Pinholes can, therefore, be dynamically opened in the firewalls using a UDP hole punching method. However, in order for the method to work, the lifetime of the state in the firewall must be known (i.e., the characteristics of the firewall must be known). In order to effectively extend a state, keepalive messages may be sent to the firewall. Sending keepalive messages too often may unnecessarily consume the air interface, whereas not sending them fast enough may result in some packet loss as a result of an unexpected closure of a pinhole upon expiration of a state.

While currently there are mechanisms for detecting firewalls (i.e., STUN), there is no mechanism for a node to identify the characteristics or configuration of the firewall (e.g., the lifetime of the state in the firewall). A need therefore exists for a mechanism by which the characteristics and configuration of a firewall lying on the communications path between an end node and a data network can be determined.

### BRIEF SUMMARY OF THE INVENTION

Generally described, various exemplary embodiments of the present invention provide an improvement over the known prior art by providing a mechanism that allows an end node or terminal that is sending and receiving data via a data network, to discover the configuration or characteristics of one or more firewalls on the path of communication between the end node and the data network. In particular, exemplary embodiments of the present invention extend middlebox configuration protocols (e.g., STUN) to enable such discovery.

According to one exemplary aspect of the present invention a method of discovering one or more characteristics of a firewall located on a communications path between an end node and a data network is provided. In one exemplary embodiment, the method includes: (1) transmitting a request for a particular response to a network entity, such as a server, by way of the data network; and (2) determining, based at least in part on whether or not the particular response requested is received, one or more characteristics of the firewall.

In one exemplary embodiment, the particular response requested is a response over some transport protocol specified in the request. If response is not received over the transport protocol, the end node knows that the firewall does not allow unsolicited incoming requests. In another exemplary embodiment, the particular response requested is a response sent after some specified time delay has expired. If this response is not received, the end node will know that the length of time associated with a state created by the firewall is shorter than the specified time delay.

According to another aspect of the present invention, a computer program product for discovering one or more characteristics of a firewall located on a communications path between an end node and a data network is provided. In one exemplary embodiment, the computer program product includes at least one computer-readable storage medium having computer-readable program code portions stored therein. These computer-readable program code portions may include: (1) a first executable portion for transmitting a request for a particular response to a network entity, such as a server, by way of the data network; and (2) a second executable portion for determining, based at least in part on whether or not the particular response is received, one or more characteristics of the firewall.

According to yet another aspect of the present invention, a system for discovering one or more characteristics of a firewall located in front of a communications device is provided. In one exemplary embodiment, the system includes a network entity, such as a server, a communications device in communication with the network entity, and a firewall located in the communications path between the communications device and the network entity. In one exemplary embodiment, the communications device is configured to generate and transmit a request for a particular response to the network entity. The communications device is further configured to determine, based at least in part on whether or not the particular response requested is received, one or more characteristics of the firewall.

According to another aspect of the present invention a communications device capable of determining one or more characteristics of a firewall located on a communications path between the communications device and a data network is provided. In one exemplary embodiment the digital device includes a processor; and a memory module in communication with the processor that stores an application executable by the processor, wherein the application is capable, upon execution, of generating and transmitting a request to a network entity, such as a server, for a particular response by way of the data network. The application is further capable, upon execution, of determining, based at least in part on whether or not the particular response requested is received, one or more characteristics of the firewall.

### BRIEF DESCRIPTION OF THE DRAWING

Having thus described the invention in general terms, reference will now be made to the accompanying drawings, which are not necessarily drawn to scale, and wherein:

FIG. 1 is a block diagram of a typical STUN configuration in accordance with exemplary embodiments of the present invention;

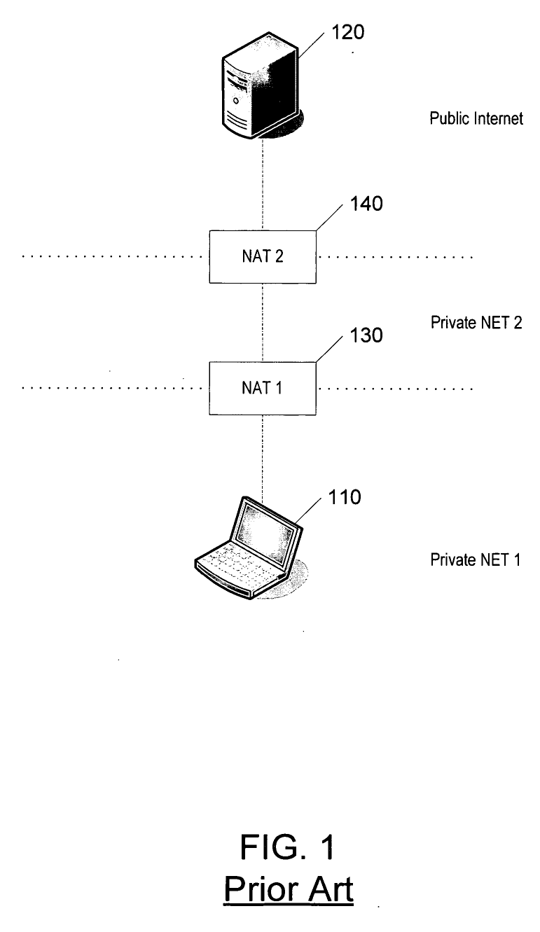

FIG. 2 is a block diagram of a system that would benefit from exemplary embodiments of the present invention;

FIG. 3 is a schematic block diagram of a mobile station capable of operating in accordance with an embodiment of the present invention;

FIG. 4 is a signal flow diagram illustrating how a REQUEST-TRANSPORT-PROTOCOL attribute could be used in accordance with exemplary embodiments of the present invention; and

FIG. 5 is a signal flow diagram illustrating how a TIME-SET-UP attribute could be used in accordance with exemplary embodiments of the present invention.

### DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Overview:

Exemplary embodiments of the present invention provide a mechanism by which an end node or terminal, which is sending and receiving data via a data network, can discover what firewalls lie on the communication path between the end node and the network, as well as the characteristics and configuration of the discovered firewalls. In order to enable this discovery mechanism, exemplary embodiments of the present invention introduce several new features to middlebox configuration protocols (e.g., STUN) to enable a user to carry out additional tests that will help identify the type of firewalls and learn their characteristics.

In particular, according to one embodiment of the present invention the STUN protocol is extended to allow a STUN Client to send a Binding Request that includes a request that the STUN Server send a response over a specific transport protocol. The response may or may not be a Binding Response. Using this feature, the STUN Client can request that the server send, for example, a TCP SYN (i.e., a synchronous idle character that enables the sending and receiving devices to maintain the same timing). If the STUN Client does not receive the TCP SYN, the user will know that the firewall that lies on the end node's communication path does not allow unsolicited incoming requests. In addition, another feature added to the STUN protocol in another exemplary embodiment allows the STUN Client to set a time delay before the STUN Server should send a response, which may or may not be a Binding Response. This will enable the STUN Client to determine the lifetime of the state dynamically created by the firewalls. These features are discussed in detail below.

For exemplary purposes only, various embodiments of the present invention are described herein in relation to the STUN protocol, and in particular to the STUN Client, the STUN Server, Binding Requests and Binding Responses. However, as will be appreciated by those of ordinary skill in the art, application of the present invention is not limited to the STUN protocol and can, in contrast, be used in conjunction with other middlebox configuration and/or discovery protocols.

System and Terminal Architecture:

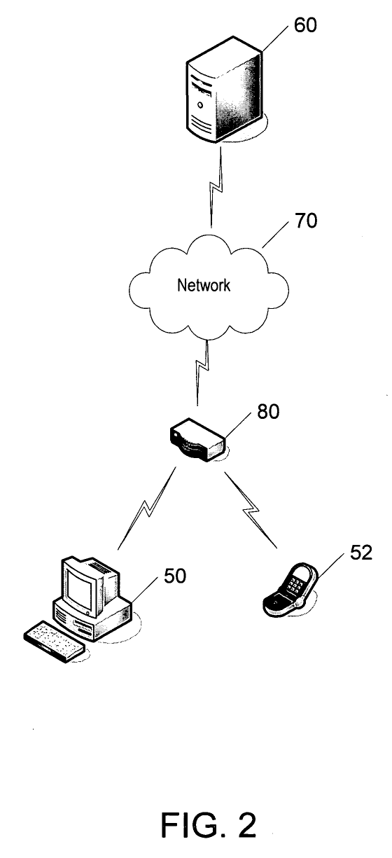

Referring to FIG. 2, an illustration of one type of system that would benefit from the present invention is provided. As shown, the system may include one or more digital devices 50, 52 operated by a user, such as, a cellular telephone, portable digital assistant (PDA), pager, personal computer (PC), laptop, or tablet, or any other similar device. These devices are connected to a network entity, such as server 60, e.g., a STUN Server, via a data network 70, such as, for example, a local area network (LAN), wireless local area network (WLAN), metropolitan area network (MAN), and/or wide area network (WAN), for the purpose of discovering middleboxes, such as firewalls and/or NATs, on the communication path between the digital device 50, 52 and the data network 70. In the exemplary embodiment shown, a screening router 80, which acts as a firewall, is placed between the digital devices 50, 52 and the data network 70, in order to protect the digital devices 50, 52 from intruders.

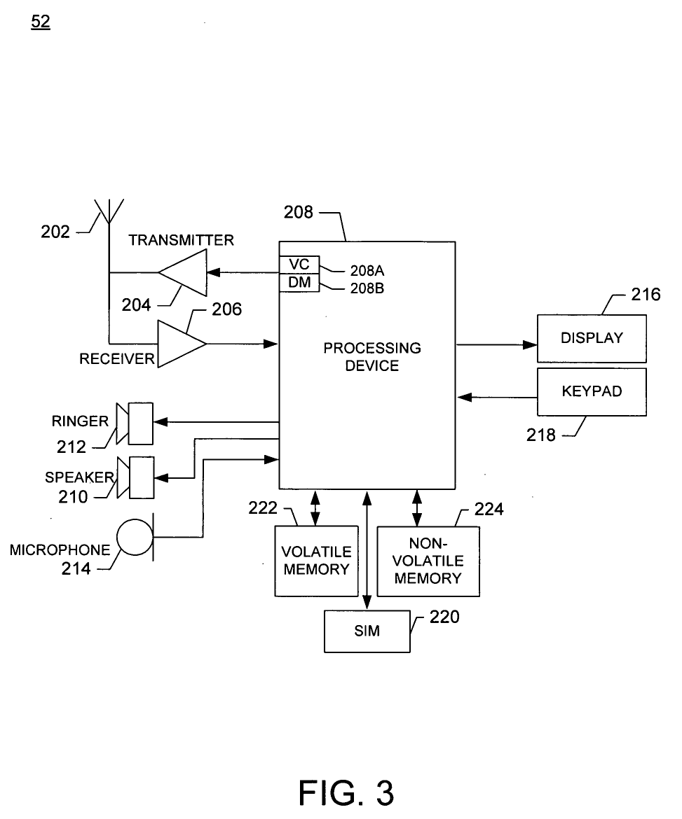

In one exemplary embodiment, at least one of the digital devices 50, 52 may be a mobile terminal, or mobile station, shown in detail in FIG. 3. The mobile terminal, or other digital device, includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 3, the entity can include an antenna 202, a transmitter 204, a receiver 206, and means, such as a processing device 208, e.g., a processor, controller or the like, that provides signals to and receives signals from the transmitter 204 and receiver 206, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 208, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 208 thus also includes the functionality to convolutionally encode and interleave message and data prior to modulation and transmission. The processing device can additionally include an internal voice coder (VC) 208A, and may include an internal data modem (DM) 208B. Further, the processing device 208 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 210, a ringer 212, a microphone 214, a display 216, all of which are coupled to the controller 208. The user input interface, which allows the mobile device to receive data, can comprise any of a number of devices allowing the mobile device to receive data, such as a keypad 218, a touch display (not shown), a microphone 214, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 220, a removable user identity module (R-UIM) (not shown), or the like, which typically stores information elements related to a mobile subscriber. In addition to the SIM, the mobile device can include other memory. In this regard, the mobile station can include volatile memory 222, as well as other non-volatile memory 224, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code for enabling the mobile station to generate a request (e.g., a Binding Request), in which the mobile station requests a particular response from a network entity, such as a server (e.g., a STUN Server). The stored computer program code may further enable the mobile station to determine, based at least in part on whether or not the particular response requested is received, one or more characteristics of a firewall located in between the mobile station and a data network.

The system, method, device and computer program product of exemplary embodiments of the present invention are primarily described in conjunction with mobile communications applications. It should be understood, however, that the system, method, device and computer program product of embodiments of the present invention can be utilized in conjunction with a variety of other applications, both in the mobile communications industries and outside of the mobile communications industries. For example, the system, method, device and computer program product of exemplary embodiments of the present invention can be utilized in conjunction with wireline and/or wireless network (e.g., Internet) applications.

Also, it should be understood that while the terminal was illustrated and described as comprising a mobile telephone, mobile telephones are merely illustrative of one type of terminal that would benefit from the present invention and, therefore, should not be taken to limit the scope of the present invention. While several embodiments of the terminal are illustrated and described for purposes of example, other types of terminals, such as portable digital assistants (PDAs), pagers, laptop computers, tablets, and other types of electronic systems including both mobile, wireless devices and fixed, wireline devices, can readily employ embodiments of the present invention.

Discovery of Middlebox Characteristics:

As discussed above, exemplary embodiments of the present invention extend middlebox configuration and/or discovery protocols, such as STUN, to enable an end node or terminal to not only discover one or more firewalls on the communication path between the end node and the data network, but also to discover the characteristics of the discovered firewalls.

According to one aspect of the invention, an end node or terminal transmits a request to a data network and, more typically, to a network entity on the data network, such as a request that a response be provided over a specific transport protocol. As the request transmitted by the end node or terminal is unsolicited, the provision or absence of a response will be indicative of whether an intervening firewall allows or prevents unsolicited requests, respectively. In one exemplary embodiment, the extension includes the introduction of a REQUEST-TRANSPORT-PROTOCOL attribute, which enables the user to determine whether or not the end node can receive unsolicited incoming requests (i.e., whether or not the firewall prohibits such receipt). As stated above, being able to receive unsolicited incoming requests is essential for many P2P applications.

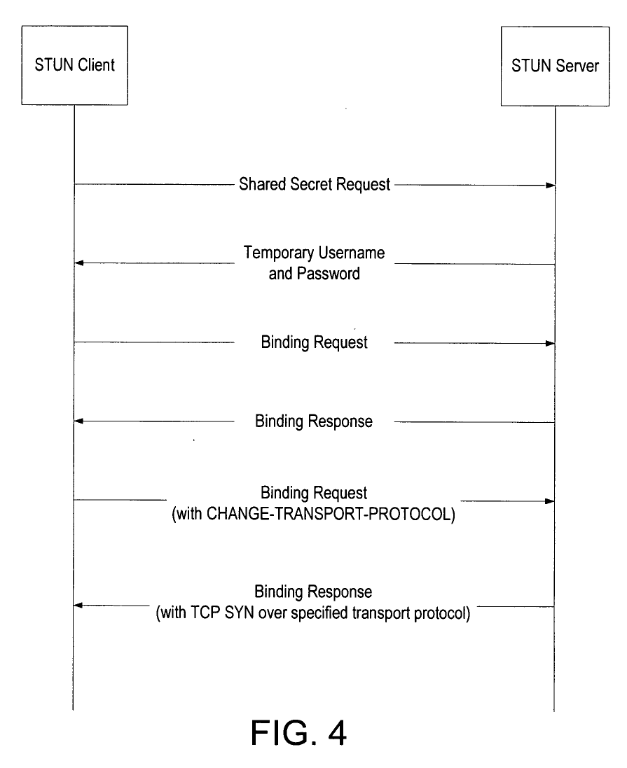

FIG. 4 is a signal flow diagram illustrating how the REQUEST-TRANSPORT-PROTOCOL attribute could be used in exemplary embodiments of the present invention in connection with the STUN protocol. As shown, and as discussed above, the STUN Client first transmits a Shared Secret Request to the STUN Server in order to receive a temporary username and password from the STUN Server for purposes of authentication and message integrity. Once the STUN Client has received the temporary username and password, the STUN Client may then send a simple Binding Request to the STUN Server in order to verify that the STUN Server is up and running. After the STUN Client receives a Binding Response from the STUN Server acknowledging that the STUN Server is running, in one exemplary embodiment, the STUN Client will then transmit a second Binding Request to the STUN Server, this time including a CHANGE-TRANSPORT-PROTOCOL attribute asking the server to send a response over a specific transport protocol. For example, the client may request that a TCP SYN be sent. If the STUN Client does not receive the TCP SYN packet, the client knows that one of the characteristics of the firewall is to block unsolicited incoming requests.

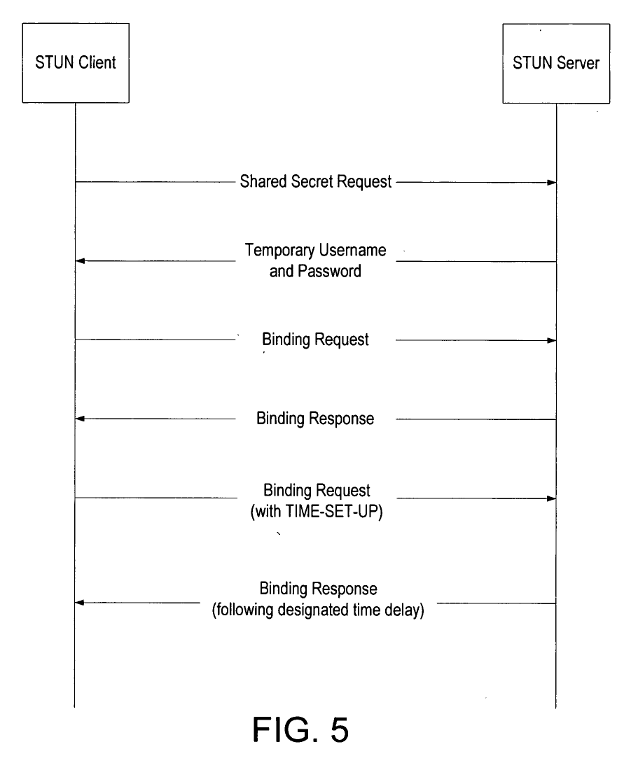

According to another aspect of the invention, the request transmitted by the end node or terminal to the data network may request a response only following expiration of a predefined delay time. If a response is not provided following the predefined delay, it can be determined that the predetermined period of time of a particular state created by an intervening firewall is less than the predefined delay time. In another exemplary embodiment, the extension to the middlebox configuration and/or discovery protocols includes a TIME-SET-UP attribute, which allows the client to specify a time delay that should occur before a response is sent by the server. This feature, therefore, can be used to determine over what pre-determined period of time a particular state created by a firewall will persist. Similar to the CHANGE-TRANSPORT-PROTOCOL attribute, the TIME-SET-UP attribute may be included in the Binding Request sent by the STUN Client to the STUN Server in exemplary embodiments of the present invention. FIG. 5 is a signal flow diagram illustrating how the TIME-SET-UP attribute could be used in exemplary embodiments of the present invention.

As in FIG. 5, the process begins where the STUN Client sends a Shared Secret Request to the STUN Server, and in return receives a temporary username and password to be used with subsequent Binding Requests and Responses. The STUN Client may again send a simple Binding Request in order to verify that the STUN Server is up and running. In this exemplary embodiment, however, the second Binding Request sent by the STUN Client includes a TIME-SET-UP attribute, rather than the CHANGE-TRANSPORT-PROTOCOL attribute, indicating a particular time delay that the STUN Server should wait before sending the Binding Response, or any other response that could or should be sent. Following the time delay, the STUN Server will then send the Binding Response.

As discussed above, Stateful Inspection Packet Filters typically create a state, which will persist for a pre-determined period of time, upon receiving a request from a node, or terminal, in a protected environment. Incoming packets matching the state will pass the firewall up until the time the state is removed. Based on the state created and the duration of the state, pinholes can be dynamically opened in the firewalls. It is, however, necessary that the duration of the state be ascertained. The above-described TIME-SET-UP attribute enables the user to determine that duration.

In particular, in one exemplary embodiment, a user may need to only know that after a certain amount of time the state (i.e., the state created by the Stateful Inspection Packet Filter in response to the second Binding Request) still exists (or, alternatively, no longer exists). In this case one request including the TIME-SET-UP attribute should be sufficient. If the user receives a response, he or she will know that after the specified time delay the state still exists. In contrast, if the user does not receive a response, he or she will know that that state no longer exists after the specified time delay. If, however, the user wishes to ascertain the exact (or generally exact) length of time associated with the state, this may require a reiterative process wherein each time the user sends a request and does not receive a response, he or she will shorten the specified time delay and resend the request. Once the user receives a response, he or she can look at the specified time delay in the latest request and determine the length of time (or range) associated with the state. This range may be further refined with additional requests having various specified time delays within the range, if so desired. As noted above, if the user receives a response, he or she will know that the state lasts at least as long as the specified time delay. In this scenario, if the user wishes to ascertain the exact (or generally exact) length of time associated with the state, this may similarly require a reiterative process wherein each time the user sends a request and receives a response, he or she will lengthen the specified time delay and resend the request. Once the user fails to receive a response, he or she can look at the specified time delay in the latest request and determine the length of time (or range) associated with the state. This range may also be further refined with additional requests having various specified time delays within the range, if so desired. In either instance, the requests are repeatedly transmitted with different time delays to ascertain the length of time associated with the state.

As will be understood by those of skill in the art, either one or both of the new attributes described above (i.e., CHANGE-TRANSFER-PROTOCOL and TIME-SET-UP) may be used alone or in conjunction with the other in order to determine the various characteristics of one or more firewalls lying on the communication path between an end node and the data network. The new attributes may further be used in combination with any of the attributes previously defined by the STUN protocol, or by any other middlebox configuration and/or discovery protocol.

As will be appreciated by one skilled in the art, the embodiments of the present invention described above may be embodied as a system, method, mobile terminal device or other apparatus, or computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program instructions (e.g., computer software) embodied in the storage medium. More particularly, the present invention may take the form of web-implemented computer software. Any suitable computer-readable storage medium may be utilized including hard disks, CD-ROMs, optical storage devices, or magnetic storage devices.

The present invention is described above with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks, although other means for implementing the functions including various combinations of hardware, firmware and software as described herein may also be employed.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of discovering one or more characteristics of a firewall located on a communications path between an end node and a data network, said method comprising:
transmitting a request for a particular response to a network entity by way of the data network; and
determining, based at least in part on whether or not the particular response requested is received, one or more characteristics of the firewall.

2. The method of claim 1, wherein the particular response requested comprises a response sent over a specific transport protocol.

3. The method of claim 2, wherein determining one or more characteristics of the firewall comprises determining whether the firewall blocks unsolicited incoming requests, wherein it is determined that the firewall does block unsolicited incoming requests if the particular response requested is not received.

4. The method of claim 1, wherein the particular response requested comprises a Transport Control Protocol (TCP) synchronous idle character (SYN), and wherein it is determined that the firewall blocks unsolicited incoming requests if the TCP SYN is not received.

5. The method of claim 1, wherein the particular response requested comprises a response sent after a specified time delay.

6. The method of claim 5, wherein determining one or more characteristics of the firewall comprises determining whether a length of time associated with a particular state created by the firewall has expired, wherein the length of time is determined to have expired if the particular response requested is not received.

7. The method of claim 5, wherein determining one or more characteristics of the firewall comprises determining a length of time associated with a particular state created by the firewall, and wherein the method further comprises:
repeatedly transmitting one or more additional requests for a response to be sent after a specified time delay, wherein the specified time delay in each additional request is different than the specified time delay in the request immediately preceding each additional request.

8. The method of claim 1, wherein the end node comprises a device on which a Simple Traversal of User Datagram Protocol (UDP) through Network Address Translators (NATs) (STUN) Client application is running, and wherein the server comprises a STUN Server.

9. A computer program product for discovering one or more characteristics of a firewall located on a communications path between an end node and a data network, wherein the computer program product comprises at least one computer-readable storage medium having computer-readable program code portions stored therein, the computer-readable program code portions comprising:
a first executable portion for transmitting a request for a particular response to a network entity by way of the data network; and
a second executable portion for determining, based at least in part on whether or not the particular response requested is received, one or more characteristics of the firewall.

10. The computer program product of claim 9, wherein the particular response requested comprises a response sent over a specific transfer protocol.

11. The computer program product for claim 10, wherein said second executable portion is capable of determining one or more characteristics of the firewall by determining whether the firewall blocks unsolicited incoming requests, wherein said second executable portion is capable of determining that the firewall does block unsolicited incoming requests if the particular response requested is not received.

12. The computer program product of claim 9, wherein said first executable portion is capable of requesting a particular response comprising a Transport Control Protocol (TCP) synchronous idle character (SYN), and wherein said second executable portion is capable of determining that the firewall blocks unsolicited incoming requests if the TCP SYN is not received.

13. The computer program product of claim 9, wherein the particular response requested comprises a response sent after a specified time delay.

14. The computer program product of claim 13, wherein said second executable portion is capable of determining one or more characteristics of the firewall by determining whether a length of time associated with a particular state created by the firewall has expired, wherein said second executable portion is capable of determining that the length of time has expired if the particular response requested is not received.

15. The computer program product of claim 13, wherein said second executable portion is capable of determining one or more characteristics of the firewall by determining a length of time associated with a particular state created by the firewall, and wherein said first executable portion is further capable of:
repeatedly transmitting one or more additional requests for a response to be sent after a specified time delay, wherein the specified time delay in each additional request is different than the specified time delay in the request immediately preceding each additional request.

16. The computer program product of claim 9, wherein the end node comprises a device on which a Simple Traversal of User Datagram Protocol (UDP) through Network Address Translators (NATs) (STUN) Client application is running, and wherein the network entity comprises a STUN Server.

17. A system for discovering one or more characteristics of a firewall located in front of a communications device, said system comprising:
a network entity;
a communications device in communication with said network entity, said communications device configured to generate and transmit to said network entity a request for a particular response; and
a firewall located on a communications path between the communications device and the server,
wherein said communications device is further configured to determine, based at least in part on whether or not the particular response requested is received, one or more characteristics of the firewall.

18. The system of 17, wherein the particular response requested comprises a response sent over a specific transport protocol.

19. The system of claim 18, wherein said communications device is further configured to determine whether the firewall blocks unsolicited incoming requests, wherein said communications device is configured to determine that the firewall does block unsolicited incoming requests if the particular response requested is not received.

20. The system of claim 17, wherein the particular response requested comprises a Transport Control Protocol (TCP) synchronous idle character (SYN), and wherein said communications device is configured to determine that the firewall blocks unsolicited incoming calls if the TCP SYN is not received.

21. The system of claim 17, wherein the particular response requested comprises a response sent after a specified time delay.

22. The system of claim 21, wherein said communications device is further configured to determine whether a length of time associated with a particular state created by the firewall has expired, wherein said communications device is configured to determine that the length of time has expired if the particular response requested is not received.

23. The system of claim 21, wherein said communications device is further configured to determine a length of time associated with a particular state created by the firewall, and wherein said communications device is further configured to:
repeatedly transmit one or more additional requests for a response to be sent after a specified time delay, wherein the specified time delay in each additional request is different than the specified time delay in the request immediately preceding each additional request.

24. The system of claim 17, wherein the network entity comprises a Simple Traversal of User Datagram Protocol (UDP) through Network Address Translators (NATs) (STUN) Server, and wherein said communications device comprises a STUN Client application.

25. A communications device capable of determining one or more characteristics of a firewall located on a communications path between the communications device and a data network, said communications device comprising:
a processor; and
a memory module in communication with the processor that stores an application executable by the processor, wherein the application is capable, upon execution, of generating and transmitting a request to a network entity for a particular response by way of the data network, and wherein said application is further capable, upon execution, of determining, based at least in part on whether or not the particular response requested is received, one or more characteristics of the firewall.

26. The communications device of claim 25, wherein the particular response requested comprises a response sent over a specific transport protocol.

27. The communications device of claim 26, wherein determining one or more characteristics of the firewall comprises determining whether or not the firewall blocks unsolicited incoming requests, wherein said firewall is determined to block unsolicited incoming requests if the particular response requested in not received.

28. The communications device of claim 25, wherein the particular response requested comprises a response sent after a specified time delay.

29. The communications device of claim 28, wherein determining one or more characteristics of the firewall comprises determining whether a length of time associated with a particular state created by the firewall has expired, and wherein the length of time is determined to have expired if the particular response requested is not received.

30. The communications device of claim 28, wherein determining one or more characteristics of the firewall comprises determining a length of time associated with a particular state created by the firewall, and wherein the application is further capable, upon execution of repeatedly transmitting one or more additional requests for a response to be sent after a specified time delay, wherein the specified time delay in each additional request is different than the specified time delay in the request immediately preceding each additional request.

31. The communications device of claim 25, wherein the application comprises a Simple Traversal of User Datagram Protocol (UDP) through Network Address Translators (NATs) (STUN) Client application, and wherein the request for a particular response is transmitted to a STUN Server.

32. A communications device capable of determining one or more characteristics of a firewall located on a communications path between the communications device and a data network, said communications device comprising:
means for generating a request for a particular response;
means for transmitting the request to a network entity by way of the data network; and
means for determining, based at least in part on whether or not the particular response requested is received, one or more characteristics of the firewall.

33. The communications device of claim 32, wherein the particular response requested comprises a response sent over a specific transport protocol, and wherein determining one or more characteristics of the firewall comprises determining whether or not the firewall blocks unsolicited incoming requests, wherein the firewall is determined to block unsolicited incoming requests if the particular response requested is not received.

34. The communications device of claim 32, wherein the particular response requested comprises a response sent after a specified time delay.

35. The communications device of claim 34, wherein determining one or more characteristics of the firewall comprises determining whether a length of time associated with a particular state created by the firewall has expired, and wherein the length of time is determined to have expired if the particular response requested is not received.

36. The communications device of claim 34, wherein determining one or more characteristics of the firewall comprises determining a length of time associated with a particular state created by the firewall, and wherein the communications device further comprises:
means for repeatedly transmitting one or more additional requests for a response to be sent after a specified time delay, wherein the specified time delay in each additional request is different than the specified time delay in the request immediately preceding each additional request.
